(19) United States
(12) Patent Application Publication
(10) Pub. No.: US 2017/0352009 A1
(43) Pub. Date: Dec. 7, 2017

(54) Method for assigning time windows for Vehicle Routing problem

(71) Applicant: International Business Machines Corporation, Armonk, NY (US)

(72) Inventors: Michael Katz, Nahariya (IL); Vladimir Lipets, Haifa, NY (US); Michael Masin, Haifa (IL); Dany Moshkovich, Yokneam Ilit (IL); Segev E. Wasserkrug, Haifa (IL)

(21) Appl. No.: 15/169,751

(22) Filed: Jun. 1, 2016

(51) Int. Cl. G06Q 10/00; G06Q 10/10

(52) U.S. Cl. CPC G06Q 10/20; G06Q 10/109

(57) ABSTRACT

A computer-implemented method, apparatus and computer program product, the method performed by a processor operatively connected to a memory, the method comprising: obtaining a schedule for handling service requests, the schedule planned offline in accordance with expected service requests for a service, the schedule comprising a number of service trips per time slot and per geographic location; receiving a service request, comprising a location in which the service is to be provided; automatically suggesting, during handling the service request, a time slot for providing the service from time slots available in the schedule for providing the service in the location; and upon acceptance of the time slot for providing the service, updating the schedule with the service being provided at the time slot.

### TECHNICAL FIELD

The present disclosure relates to solving scheduling problems in general, and in particular to solving vehicle routing with time windows problems.

### BACKGROUND

Mobile Workforce Scheduling Problem is a general name for a large variety of problems, including Vehicle Routing Problem with Time Windows (VRPwTW). In VRPwTW it is required to assign an agent to a task at a location, wherein each such service or delivery has a time window within which the visit or delivery has to take place. In one example, a technician visit is to be scheduled for solving a problem at a customer site, on a time window that is acceptable for the customer. In some applications, assigning each service call may require that the technician be qualified for fixing the relevant problem reported by the customer, has the adequate equipment, or that other resources are available or conditions are met.

Vehicle Routing Problem (VRP) is an NP-hard problem, and so is VRPwTW. VRPwTW may be especially challenging not only due to the additional constraints, but also since it may be required to solve the problem in near real-time, for example when a customer is calling to request service, and a time window has to be suggested within a few seconds.

In existing solutions, assigning the time windows to the tasks has great impact on the efficiency of the solution, sometime even more than selecting the routing solution.

### BRIEF SUMMARY

One exemplary embodiment of the disclosed subject matter is a computer-implemented method performed by a processor operatively connected to a memory, the method comprising: obtaining a schedule for handling service requests, the schedule planned offline in accordance with expected service requests for a service, the schedule comprising a number of service trips per time slot and per geographic location; receiving a service request, comprising a location in which the service is to be provided; automatically suggesting, during handling the service request, a time slot for providing the service from time slots available in the schedule for providing the service in the location; and upon acceptance of the time slot for providing the service, updating the schedule with the service being provided at the time slot.

One exemplary embodiment of the disclosed subject matter is a computer-implemented method for solving a vehicle routing problem with time windows, comprising: obtaining a collection of expected requests, each expected request associated with a location and a time window; planning a schedule in accordance with the collection of service requests; receiving a service request, comprising a location in which service is to be provided; automatically suggesting during handling the service request, a time slot for providing the service, from time slots available in the schedule for providing the service in the location; upon acceptance of the time slot for providing the service, updating the schedule; and enhancing the schedule as updated.

Yet another exemplary embodiment of the disclosed subject matter is a computerized apparatus having a processor, the processor being adapted to perform the steps of: obtaining a schedule for handling service requests, the schedule planned offline in accordance with expected service requests for a service, the schedule comprising a number of service trips per time slot and per geographic location; receiving a service request, comprising a location in which the service is to be provided; automatically suggesting, during handling the service request, a time slot for providing the service from time slots available in the schedule for providing the service in the location; and upon acceptance of the time slot for providing the service, updating the schedule with the service being provided at the time slot.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a flowchart diagram of a method for solving a vehicle routing problem with time windows, in accordance with some exemplary embodiments of the disclosed subject matter; and

FIG. 2 is a block diagram of an apparatus for solving a vehicle routing problem with time windows, in accordance with some exemplary embodiments of the disclosed subject matter.

### DETAILED DESCRIPTION

One technical problem handled by the disclosed subject matter is the need to solve a vehicle routing problem with time windows (VRPwTW) in an optimized and efficient manner In particular, it may be required to respond to a customer calling and requesting service at her premises or at another location to which a technician should arrive. Within a short time, for example during the call, it may be required to coordinate with the customer a time window, also referred to as a time slot, for the technician's visit or delivery.

Another technical problem is that the overall solution for the service provider should be optimized, i.e., the solution should be efficient over a predetermined time frame such as a day, a week, or the like relatively to other solutions, for example by saving on resources such as travel time, travel distance, assigning people to tasks they are competent to, or the like.

One technical solution relates to splitting the solution planning into an offline stage and an online stage. On the offline stage, initial schedules, including allotted time slots are planned in accordance with expected service requirements. Optionally, the schedule indicates for each time window, for example Monday 8 AM-12 midday, the number and areas of service requests that can be handled. The number and location distribution of the service requests upon which the schedule is planned, can be selected to fit the expected number and location distribution, as based on past experience, forecasted events such as launch of a new product, or the like. The offline solution may be made robust to demand uncertainties, since the time it takes to calculate it is not strictly limited. The offline solution may also be periodically updated to handle extreme or unexpected demand realizations.

On the online stage, when a customer calls to request service, it is determined to which time slot the service request fits, for example, in which time slot of the planned schedule there is vacancy to a call at the particular area, with or without taking into consideration additional limitations. That time slot may be suggested to the customer. If the time slot is acceptable for the customer, it is agreed and indicated in the schedule. Otherwise a different time slot is suggested until agreement is reached. The schedule may then be updated to accommodate the added service request.

One technical effect of the disclosure is the combination of an optimal or near optimal solution enabled by offline planning the schedule, with the immediate response provided to customers in selecting an appropriate time slot.

Another technical effect of the disclosure is the scalability of the solution: while planning a schedule is done offline and can take a long time without interrupting ongoing service, suggesting a time slot to a customer may be performed relatively fast, for example within a few seconds, even for a very large number of customers.

Yet another technical effect of the disclosure is that due to the equivalence between this problem and other NP—hard problems, the solution may be adapted and used for other domains and is not limited to VRPwTW.

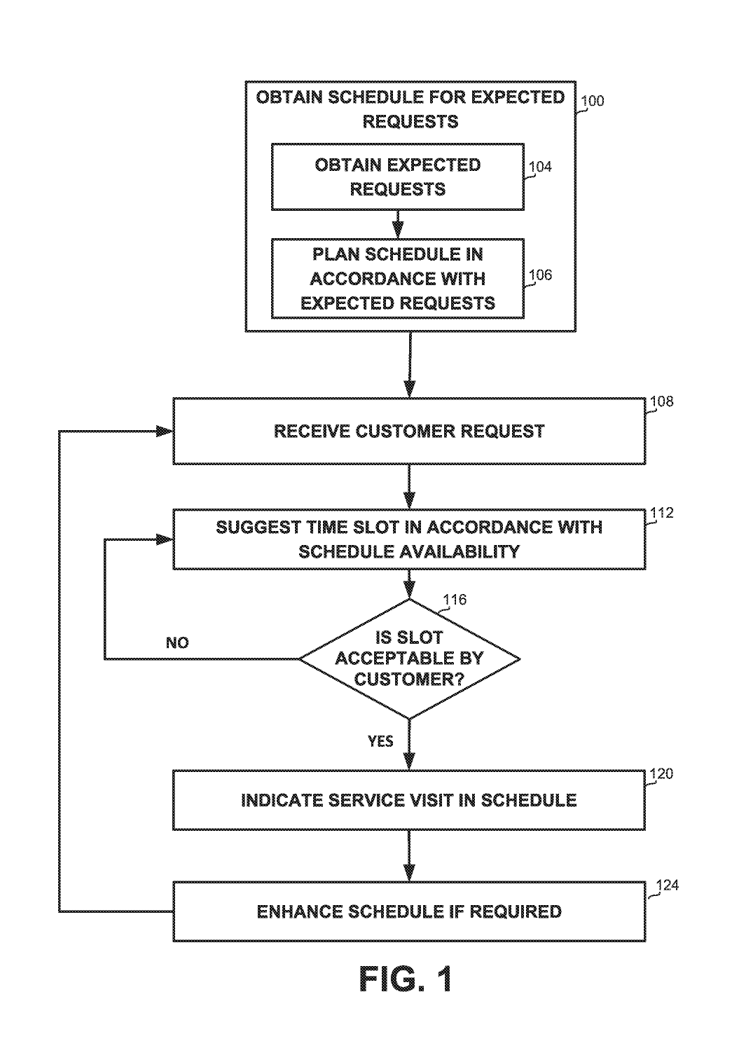

Referring now to FIG. 1, showing a flowchart diagram of a method for solving a vehicle routing problem with time windows.

On step 100, a schedule planned in accordance with expected service requests may be obtained.

In some exemplary embodiments of the disclosure, the schedule may be obtained by receiving it over a communication channel, retrieving from a storage device, or the like. The schedule may comprise at least a number of service trips allotted per time slot and per geographic location.

In some embodiments, obtaining the schedule may comprise the following steps:

On Step 104, a collection of expected service requests may be obtained. The service requests may be obtained from a user, a database, compiled from past requests which may be aggregated for example by area, or obtained in any other manner. The service requests may be based on past experience, forecast, expected events such as product launch, or the like, wherein each expected service request may comprise a location, a time window, and possibly additional parameters such as tools, expertise, or the like.

On Step 106, a schedule may be planned in accordance with the expected service requirements. It will be emphasized that the offline planning is not limited to one period, or “next day” model, wherein the service requests are known. Instead, in some embodiments, the offline planning may relate to multi-day or multi-time windows model, which is based on expected service requests.

In some embodiments, the planned schedule may be improved by aggregating separate locations into areas, in order to improve the demand estimation and reduce the model size.

Planning the schedule may be performed by using Robust Optimization or stochastic programming techniques and may handle uncertainties related for example to demand, transportation and service time parameters, or the like. It will be appreciated that the parameters used for planning the schedule may depend on the certainty level of the demand. For example, if the demand is known to be steady, than a less robust optimization approach may be taken, and vice versa.

In alternative embodiments, the schedule may be planned in any other manner, such as exhaustive search or any other.

The offline planning may determine an optimal or near optimal solution for the s expected demand, and may allocate existing requests, such as pre-received orders. Allocating the existing orders may be performed once the schedule is planned, similarly to how such allocation is performed during customer calls, as detailed in association with step 112 below. Alternatively, the existing requests may be reduced from the expected requests and allocated in a different manner, since they may have higher certainty.

On step 108 a service request may be received, for example by phone, e-mail, instant message, web site, application, or any other manner. The customer or another person or entity issuing the request may provide the required service location and optionally additional parameters, such as device model which may enable the determination of the required technician expertise, required equipment, or the like.

On step 112, a time slot may be suggested to the customer from the time slots for which there is availability for the required location, and optionally in accordance with the other parameters. It will be appreciated that while offline planning of the schedule may take a long time, for example a number of minutes to a number of hours or even a few days, assigning an available time slot to a customer visit according to the customer's request can be done in a very short time, for example a few seconds.

When several options exist for allocating a service request, the allocation could be done according to any required policy which may change between service requests, such as but not limited to: an agent with a known order at the same or nearby location; within the first available time slot; to an agent with the lowest utilization; according to minimum marginal travel time or cost; the latest time slot acceptable for the user, in order to leave earlier time slots for other customers which may be less tolerant, or the like.

If the optimization model had different demand scenarios, then the slot used in most scenarios may be selected by majority voting between the scenarios.

On step 116 it may be determined whether the suggested time slot suits the customer, for example by receiving a vocal response, receiving an indication for a checked control in an application, or the like.

If the time slot does not suit the customer, then step 112 may be repeated and another time slot may be suggested. It will be appreciated that further suggested time slots may be less optimal but still adequate. Alternatively, later and later time slots may be suggested.

If the time slot suits the customer, then upon acceptance of the time slot, on step 120 the service visit is indicated in the schedule, for example by updating the available services for this time slot. The visit details may or may not be updated in the schedule.

On step 124 the schedule may be enhanced, for example fully or partially re-computed in accordance with the updated information such as scheduled visits. It will be appreciated that the schedule may be enhanced after each visit is scheduled, once every predetermined period of time, such as every hour or every day, after a visit was scheduled to a non-optimal time slot due to customer's time table, or the like. In some embodiments, the schedule may be enhanced after at least a predetermined number of service requests have been received, or after at least a predetermined idle time in which no or little service requests have been received. Such situations may introduce deviations from the expected course of received service requests and it may thus be beneficial to enhance the schedule and adapt it to the current situation.

If the schedule is enhanced every predetermined period of time, for example every day, then the system may behave in accordance with a “folding horizon” paradigm in which it keeps behaving and suggesting time slots in accordance with the schedule as it was at the beginning of the period, and in accordance with a “rolling horizon” paradigm when moving to the next period of time, when the schedule is enhanced.

It will be appreciated that the solution is scalable, due to the offline nature of the heavy computational tasks. It will also be appreciated that a variable degree of uncertainty may be allowed, depending on the number and nature of the expected service requests.

In some embodiments, enhancing the schedule may relate to computing the schedule from scratch. In some embodiments, enhancing the schedule may relate to using the existing schedule as a basis and changing or optimizing some details or entries, such as the distribution of calls between time slots and entries. It will be appreciated that any of the two enhancement types, and possibly additional ones, may be used in accordance with the amount of changes such as the number or type of requests accepted since the schedule has been planned, the time elapsed since the schedule was planned, the computational load on the system, the arrival rate of new requests, user selection, or the like.

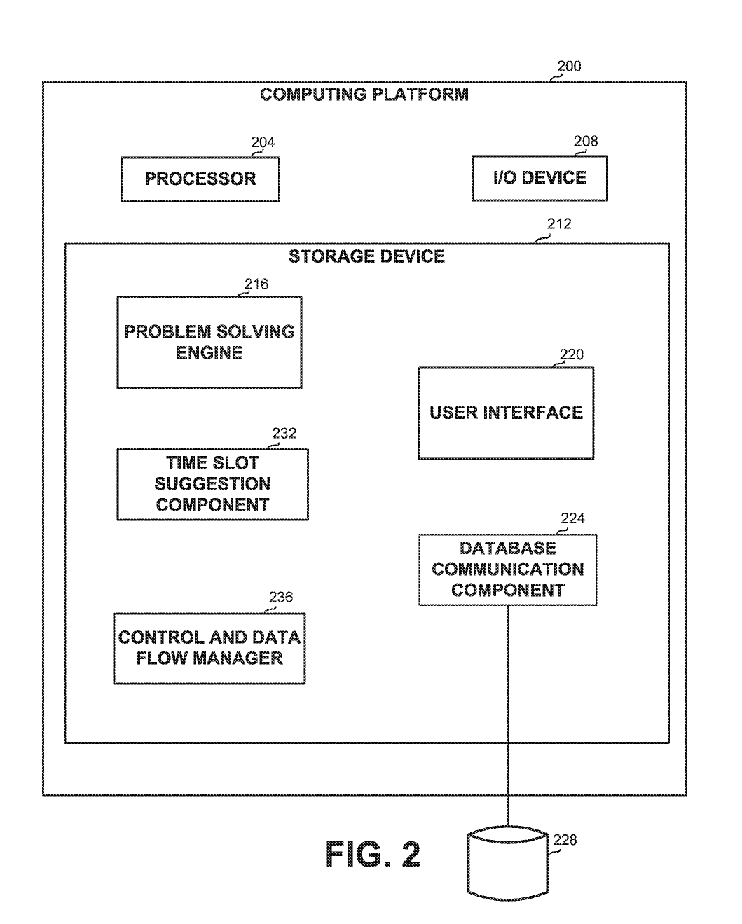

Referring now to FIG. 2, showing a block diagram of an apparatus for defining models, in accordance with some exemplary embodiments of the disclosed subject matter.

The apparatus may be implemented on computing platform 200 comprising a Processor 204. Processor 204 may be one or more Central Processing Unit (CPU), a microprocessor, an electronic circuit, an Integrated Circuit (IC) or the like. Processor 204 may be configured to provide the required functionality, for example by loading to memory and activating the modules stored on Storage Device 212 listed below.

Computing Platform 200 may also comprise Input/Output (I/O) Device 208 such as a display, a pointing device, a keyboard, a touch screen, or the like. I/O Device 208 may be utilized to provide output to and receive input from a user, for example creating the model

Computing Platform 200 may also comprise a Storage Device 212, such as a hard disk drive, a Flash disk, a Random Access Memory (RAM), a memory chip, or the like. In some exemplary embodiments, Storage Device 212 may retain program code operative to cause Processor 204 to perform acts associated with any of the modules listed below.

It will be appreciated that Computing Platform 200 may be implemented as one or more computing platforms which may be in communication with one another. It will also be appreciated that Processor 204 may be implemented as one or more processors, whether located on the same platform or not.

Storage Device 212 may comprise Problem Solving Engine 216, for solving an optimization problem. Problem Solving Engine 216 may be adapted to solve a problem from scratch, for example planning a schedule based only on known and expected requirements.

Problem Solving Engine 216 may also be adapted to enhance a solution, for example receive an existing schedule and perform some optimizations, based on future service requirements that have been received since the schedule was planned. For example, the received requests may be indicated as constraints which cannot be moved, thus optimizations may be performed by optionally moving or changing time slots for other expected required visits.

Problem Solving Engine 216 may be nay proprietary or third party engine. Problem Solving Engine 216 may be implemented as a Robust Optimization engine. In solving an optimization problem with a Robust Optimization engine, a tradeoff may exist between the robustness of the solution, e.g., how much it can endure changes, vs. the input uncertainty. Thus, if the demand is known to be relatively steady, a lesser degree of robustness may be used, in exchange to the solution being better optimized. The demand being relatively constant may be expressed, for example, in a smaller range of the input parameters.

In other embodiments, any other Stochastic Programming technique may be used by problem solving engine 216.

Storage Device 212 may comprise User Interface (UI) 220, which may be used by a user such as a person responsible for determining the schedule, for entering data and receiving results. Further components of UI 220 can be used by agents while communicating with customers, wherein UI 220 may display to an agent a suggested time window, and the agent may indicate whether the time window suits the customer, or another time windows should be suggested. Further components if UI 220 may be used by an end user requesting a service via a computerized application such as a web application.

Storage Device 212 may comprise a Database Communication Component 224 for communicating with one or more Databases 228, comprising for example past data related to service demands, past schedules, customer details, or additional data. Database Communication Component 224 may be used by other components when planning, using, or updating a schedule, or otherwise using the system. Databases 228 may comprise any one or more interconnected co-located or distributed databases, of one or more types.

Storage Device 212 may comprise a Time Slot Selection Component 232 for selecting a time slot to be suggested to a customer requiring service at a location, in accordance with the currently active schedule, as may have been updated with service trips allotted in response to previous customer requests.

Storage Device 212 may comprise a Data and Control Flow Manager 236, for activating Problem Solving Engine 216 or other components, and providing each activated component with access to the data required for its operation. For example, Data and Control Flow Handler 236 may be responsible for determining when to activate Problem Solving Engine 216 to plan a new schedule based on expectations, when to activate it to enhance the current schedule as updated since its planning due to received service requests, and supply or make sure it has the required input for each case.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method performed by a processor operatively connected to a memory, the method comprising:
obtaining a schedule for handling service requests, the schedule planned offline in accordance with expected service requests for a service, the schedule comprising a number of service trips per time slot and per geographic location;
receiving a service request, comprising a location in which the service is to be provided;
automatically suggesting, during handling the service request, a time slot for providing the service from time slots available in the schedule for providing the service in the location; and
upon acceptance of the time slot for providing the service, updating the schedule with the service being provided at the time slot.

2. The method of claim 1, wherein obtaining a schedule comprises:
obtaining a collection of expected service requests, each expected service request associated with a location and a time window; and
planning the schedule in accordance with the collection of expected service requests.

3. The method of claim 2, wherein planning the schedule is performed by robust optimization.

4. The method of claim 2, wherein planning the schedule is performed using a stochastic programming technique.

5. The method of claim 1, wherein automatically suggesting the time slot comprises suggesting a nearest time slot having availability.

6. The method of claim 1, further comprising enhancing the schedule subject to received service requests or idle periods exceeding a threshold.

7. The method of claim 1, further comprising enhancing the schedule as updated.

8. The method of claim 7, wherein the schedule is enhanced after every service request is accepted.

9. The method of claim 7, wherein the schedule is enhanced every predetermined period of time.

10. A computer-implemented method for solving a vehicle routing problem with time windows, comprising:
obtaining a collection of expected requests, each expected request associated with a location and a time window;
planning a schedule in accordance with the collection of service requests;
receiving a service request, comprising a location in which service is to be provided;
automatically suggesting during handling the service request, a time slot for providing the service, from time slots available in the schedule for providing the service in the location;
upon acceptance of the time slot for providing the service, updating the schedule; and
enhancing the schedule as updated.

11. A computerized apparatus having a processor, the processor being adapted to perform the steps of:
obtaining a schedule for handling service requests, the schedule planned offline in accordance with expected service requests for a service, the schedule comprising a number of service trips per time slot and per geographic location;
receiving a service request, comprising a location in which the service is to be provided;
automatically suggesting, during handling the service request, a time slot for providing the service from time slots available in the schedule for providing the service in the location; and
upon acceptance of the time slot for providing the service, updating the schedule with the service being provided at the time slot.

12. The apparatus of claim 11, wherein obtaining a schedule comprises:
obtaining a collection of expected service requests, each expected service request associated with a location and a time window; and
planning the schedule in accordance with the collection of expected service requests.

13. The apparatus of claim 12, wherein planning the schedule is performed by robust optimization.

14. The apparatus of claim 13, wherein planning the schedule is performed using a stochastic programming technique.

15. The apparatus of claim 12, wherein automatically suggesting the time slot comprises suggesting a nearest time slot having availability.

16. The apparatus of claim 12, wherein the processor is further adapted to enhance the schedule.

17. The apparatus of claim 16, wherein the p schedule is enhanced subject to received service requests or idle periods exceeding a threshold.

18. The apparatus of claim 16, wherein the schedule is enhanced after every service request is accepted.

19. The apparatus of claim 16, wherein the schedule is enhanced every predetermined period of time.
